(19) United States
(12) Patent Application Publication
(10) Pub. No.: US 2002/0058476 A1
(43) Pub. Date: May 16, 2002

(54) Apparatus,system and method for transmitting upstream and downstream signals in a cellular communication system having a wireless backhaul

(76) Inventor: Daniel J. Huslig, San Diego, CA (US)

Correspondence Address: ATTN: Terramce A. Meador, GRAY CARY WARE & FREIDENRICH, Suite 1100, 4365 Executive Drive, San Diego, CA, 92121-2133, US

(21) Appl. No.: 09/991,720

(22) Filed: Nov. 13, 2001

Related U.S. Application Data
(60) Provisional application No. 60/248,187, filed on Nov. 13, 2000.

(51) Int. Cl. H04B 3/36

(52) U.S. Cl. 455/7; 455/561; 455/445

(57) ABSTRACT

Link signals exchanged between a base station and a distribution station within a cellular communication system have reversed sidebands as compared to corresponding coverage signals exchanged with mobile stations. An odd number of high side mixing procedures are performed on a received coverage signal to form a link signal with reversed sidebands. A coverage signal is formed by performing an odd number of high side mixing procedures on a received link signals to reverse the sidebands to their original format.

### RELATED APPLICATION

This application claims priority to U.S. Provisional Patent Application No. 60/248,187, entitled “INVERTING SIDEBANDS OF LINK SIGNAL IN A SPICE SYSTEM”, filed on Nov. 13, 2000, and is incorporated herein in its entirety.

### BACKGROUND OF THE INVENTION

The invention relates in general to wireless communication and more specifically to transmitting upstream and downstream signals in a cellular communication system having a wireless backhaul.

Cellular communication systems provide wireless service to mobile stations using base stations where each base station provides service to mobile stations within a cell corresponding to the particular base station. Frequency bandwidth is distributed between the base stations allowing for frequency re-use in cells that are spaced at a sufficient distance. In many cellular systems, the base station communicates directly with mobile stations within the cell using the coverage frequencies assigned to the cell. Systems in accordance with the description in U.S. Pat. No. 5,787,344 issued to Stefan Scheinert on Jul. 28, 1998, entitled “Arrangement of Base Transceiver Stations of an Area-Covering Network”, however, provide service to mobile stations through clusters of distribution stations connected through a wireless backhaul. In such systems, a base interface station connected to the base station communicates with the base station using coverage frequencies while communicating with the distribution stations using link frequencies. In some implementations, the link channels at the link frequencies are within frequency bandwidths assigned to the base station for communication with mobile stations and are often referred to as “in-band”.

In accordance with the procedures and protocols of the cellular system and network, the mobile stations establish communication by responding to information forwarded or initiated from the base station. In systems using the in-band link channels, certain situations may occur where the mobile units will attempt to communicate on the link channel. Therefore, there is need for an apparatus, system and method for efficiently allocating link channels and coverage channels in a cellular communication system with a wireless backhaul.

### BRIEF DESCRIPTION OF THE DRAWINGS

FIG. 1 is block diagram of a cellular communication system using a wireless backhaul in accordance with an exemplary embodiment of the invention.

FIG. 2 is a graphical representation of a frequency spectrum in accordance with the exemplary embodiment of the invention.

FIG. 3 is a graphical representation of a series of states of the frequency spectrum depicting the frequency shifting of the coverage signal to the link signal in accordance with the exemplary embodiment of the invention where the frequency of the second mixing signal is higher than the link frequency.

FIG. 4 is a graphical representation of a series of states of the frequency spectrum depicting the frequency shifting of the coverage signal to the link frequency to form the link signal in accordance with the exemplary embodiment of the invention where the frequency (LO₁) of the first mixing signal is higher than the link frequency.

FIG. 5 is a graphical representation of a series of states of the frequency spectrum depicting the frequency shifting of the link signal to the coverage frequency to form the coverage signal in accordance with the exemplary embodiment of the invention where the frequency (LO₁) of the first mixing signal is lower than the link frequency.

FIG. 6 is a graphical representation of a series of states of the frequency spectrum depicting the frequency shifting of the link signal to the coverage frequency to form the coverage signal in accordance with the exemplary embodiment of the invention where the frequency (LO₁) of the first mixing signal is greater than the link frequency.

FIG. 7 is a block diagram of an interface station in accordance with the exemplary embodiment of the invention.

FIG. 8 is a block diagram of a distribution station in accordance with the exemplary embodiment of the invention.

FIG. 9 is a block diagram of a downstream frequency shifter in accordance with exemplary embodiment of the invention suitable for use within the interface station and the distribution station.

FIG. 10 is a block diagram of an upstream frequency shifter suitable for use in the distribution station and the interface station.

FIG. 11 is a flow chart of a method of communicating between the base station and a mobile station in accordance with the exemplary embodiment of the invention.

FIG. 12 is a flow chart of a method of communicating between a cellular base station and a distribution station in accordance with the exemplary embodiment of the invention.

FIG. 13 is a flow chart of a method of shifting a link signal to a coverage signal in accordance with the exemplary embodiment of the invention.

FIG. 14 is a flow chart of a method of shifting a coverage signal to a link signal in accordance with the exemplary embodiment of the invention.

### DETAILED DESCRIPTION OF THE PREFERRED EMBODIMENTS

In an exemplary embodiment of the invention, a base station communicates with one or more distribution stations using link signals where the sidebands of the link signals are reversed compared to the coverage signals used for communication with mobile stations. A link signal upper-sideband of the link signal corresponds to a coverage signal lower-sideband of a coverage signal exchanged with the mobile station. A link signal lower-sideband of the link signal corresponds to a coverage signal upper-sideband of the coverage signal. In the exemplary embodiment, the link signal is a frequency modulated carrier signal having a carrier frequency equal to a link frequency. The link signal upper-sideband is spectrally located above the link frequency and the link signal lower-sideband is spectrally located below the link frequency.

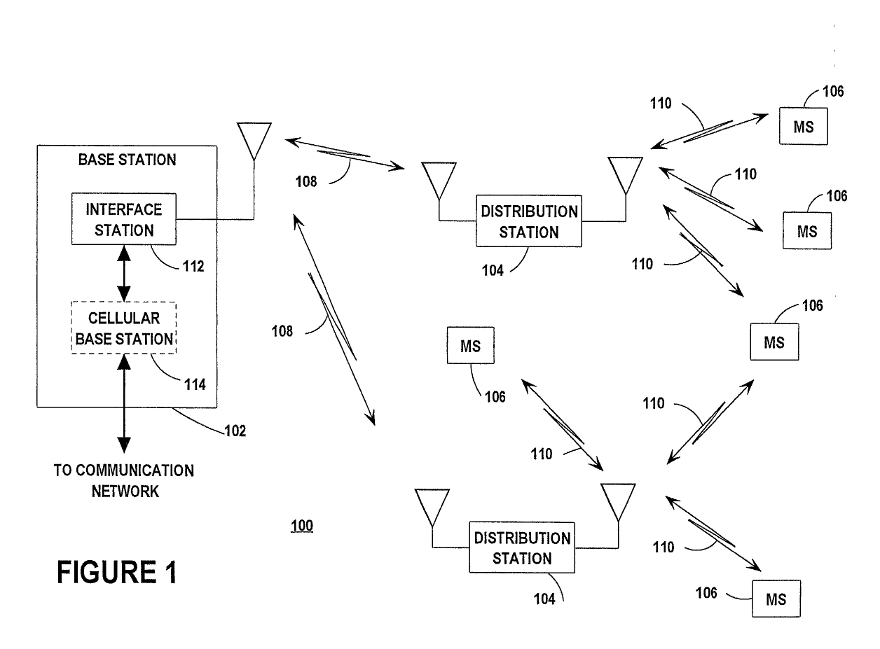

FIG. 1 is a block diagram of a wireless communication system 100 in accordance with the exemplary embodiment of the invention. The base station 102 communicates through a link channel 108 with the distribution stations 104 using link signals while corresponding coverage signals are exchanged through a coverage channel 110 between the distribution stations 104 and the mobile stations 106. In the exemplary embodiment, the base station 102 transmits a downstream link signal at a downstream link frequency to one or more distribution stations 104 within a cluster through the link channel 108. The distribution stations 104 frequency shift the downstream link signal to a downstream coverage frequency to form a downstream coverage signal. Each of the distribution stations 104 within the cluster transmits the downstream coverage signal to mobile stations 106 within the service area of a cluster. Therefore, in the exemplary embodiment, the cluster of distribution stations 104 simulcast the downstream coverage signal to the mobile stations 106 within the service area of the cluster. Those skilled in the art will recognize that the where multiple versions of the downstream coverage signal are transmitted to a mobile station 106, the wireless coverage channel 110 has similar characteristics to a wireless channel experiencing reflection, interface and fading.

In the upstream direction, the one or more distribution stations 104 receive an upstream coverage signal transmitted from a mobile station 106 at an upstream coverage frequency. The distribution stations 104 frequency shift the upstream coverage signal to an upstream link frequency and transmit the resulting upstream link signal to the base station 102. Multiple distribution stations 104 may receive the upstream coverage signal from a particular mobile station 106 and transmit corresponding upstream link signals to the base station 102. The link channel 108, therefore, may contain multiple versions of an upstream link signal. Those skilled in the art will recognize that the resulting upstream link channel has characteristics similar to a multipath wireless channel where multiple versions of a signal are received through the channel.

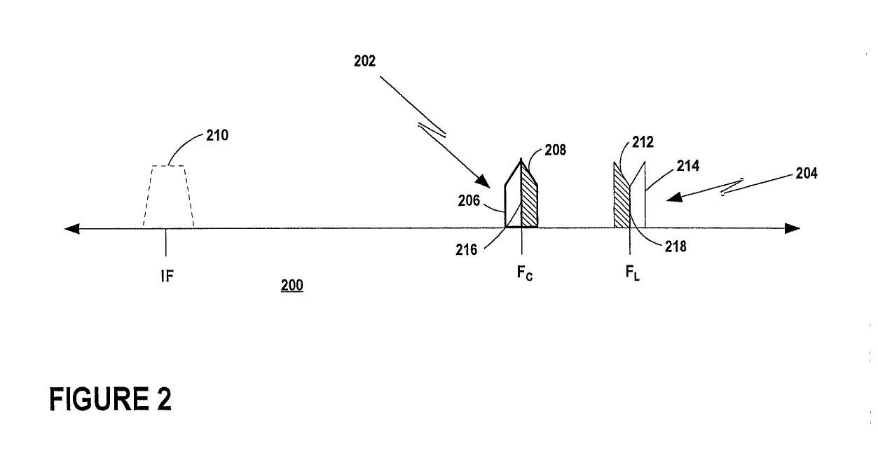

The link channel 108 includes a downstream link channel at the downstream link frequency and an upstream link channel at the upstream link frequency. As explained below in further detail with reference to FIG. 2, the sidebands of the link signals are reversed relative to the coverage signals.

Although the present invention may be utilized in accordance with a variety of communication systems, modulation techniques, and protocols, the wireless communication system 100 is implemented as part of a GSM cellular system in the exemplary embodiment. The communication system 100 includes at least one base station 102, and one distribution station 104. In the exemplary embodiment, a geographic region is divided into cells where a single base station 102 provides wireless service to mobile stations 106 within a cell through clusters of distribution stations 104 located within the cell. Examples of implementations of cellular systems having a wireless backhaul are discussed in detail in U.S. Pat. No. 5,787,344 issued to Stefan Scheinert on Jul. 28, 1998, entitled “Arrangement of Base Transceiver Stations of an Area-Covering Network” and which is incorporated by reference herein.

In the exemplary embodiment, the interface station 112 is connected to a cellular base station 114 that is part of a conventional GSM cellular system to form the base station 102. The base station 102 is connected to a communication network that includes various networks and systems such as other parts of the cellular system and a Public Switched Telephone Network (PSTN). The base station exchanges data, control and other information with the appropriate components of the communication network. Components of the cellular system such as base station controllers, switches and Operation and Maintenance Centers (OMC) provide the necessary management and control in accordance with known techniques.

The cellular base station 114 is shown as a block having a dashed line to illustrate that the base station 102 may be single integrated unit. Therefore, the cellular base station 114 may be a separate device from the interface station 112 or the base station 102 may be a single integrated unit having the functionality of the interface station 112 and the cellular base station 114 as described herein. The cellular base station 114 is likely to be separate from the interface station 112 where a simulcast communication system with distribution stations 104 is integrated with an existing cellular infrastructure and the interface station 112 is connected to an existing cellular base station 114. Those skilled in the art, however, will recognize the various suitable configurations of the interface station 112 and the cellular base station 114 and implementations of the base station 102 in accordance with the teachings herein. For example, the functionality of the interface station 112 can be implemented in a cellular base station 114 by modifying a conventional cellular base station or manufacturing an integrated base station that functions as both a cellular base station 114 and an interface station 112. Further, the interface station 112 and the cellular base station 114 can be co-located or can be in different locations. In the exemplary embodiment, the interface station 112 is connected to the cellular base station 114 through a coaxial cable. Communication and control signals, however, can be transmitted between the two units (112, 114) using a cable, radio frequency link, microwave link or any other type of wired or wireless communication channel.

Each cellular base station 114 communicates over a coaxial cable with the corresponding interface station 112 using a set of communication frequencies allocated to the base station coverage region of the base station 102. The interface station 112 communicates with several distribution stations 104 within a sector over the link channel 108 using a the pair of link frequencies. The base station coverage regions of the base station 102 are partitioned into sectors, where a dedicated set of frequencies is used for communicating with mobile stations 106 within the sector. A suitable frequency allocation plan within a cellular system includes partitioning the base station coverage region into three sectors and dedicating four frequencies within a downstream frequency bandwidth and four frequencies within an upstream frequency bandwidth per sector. Time division multiplexing (TDM) techniques are used to provide eight time slots per frequency where at least one time slot within a sector is reserved for control and system management functions. Each of the distribution stations 104 within a particular sector uses the set of coverage frequencies (coverage channels) allocated to the particular sector to communicate with one or more mobile stations 106 over the coverage channel 110. In the exemplary embodiment, wireless service is not provided directly by the base station 102 to the mobile stations 106. Those skilled in the art will recognize that the frequency allocation scheme may be modified to meet the requirements of a particular base station coverage area or system 100.

FIG. 2 is graphical representation of a frequency spectrum 200 in accordance with the exemplary embodiment of the invention. In FIGS. 2-4, the coverage signal 202 is represented by a geometric shape that is symmetrical with respect to the center frequency of the coverage signal at F₁. Those skilled in the art will recognize that the geometric shape representation is for illustrative purposes and an observation of the radio frequency energy within the frequency spectrum 200 does not necessarily present such a shape. Further, the relative distances and dimensions of the signal representations and their positions within the frequency spectrum 200 are not necessarily to scale in the Figures. The coverage signal 202 includes a coverage signal lower-sideband 206 below the center frequency 216 and a coverage signal upper-sideband 208 above the center frequency 216. In order to more easily illustrate the reversal of the sidebands (206, 208), the coverage signal upper-sideband 208 is cross hatched with diagonal lines in the Figures. In FIG. 2 through FIG. 7, the link signal is illustrated as having a link frequency that is higher than the coverage frequency of the coverage signal. The link frequency, however, may be less than the coverage signal.

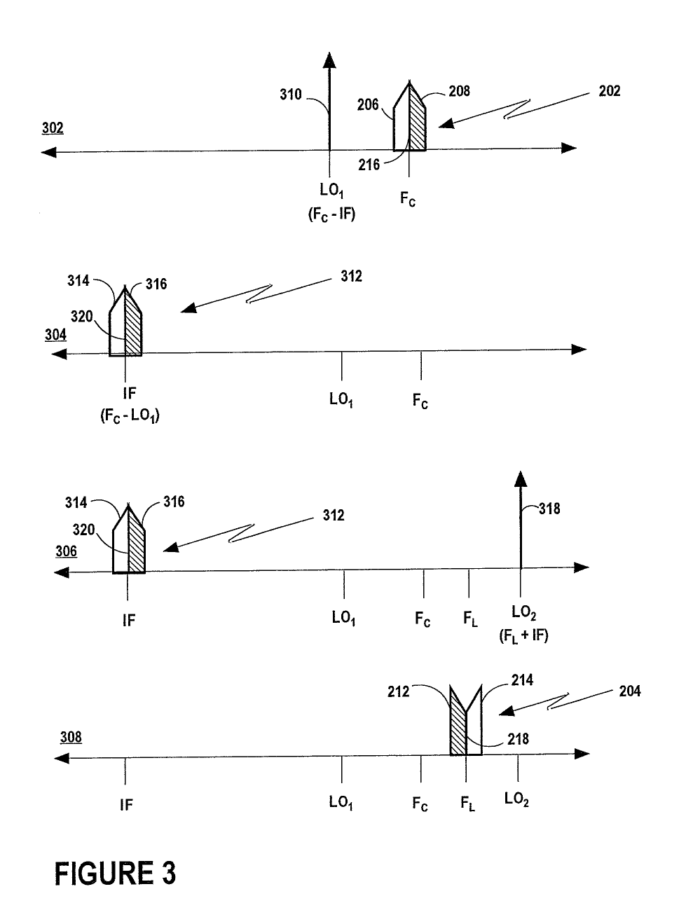

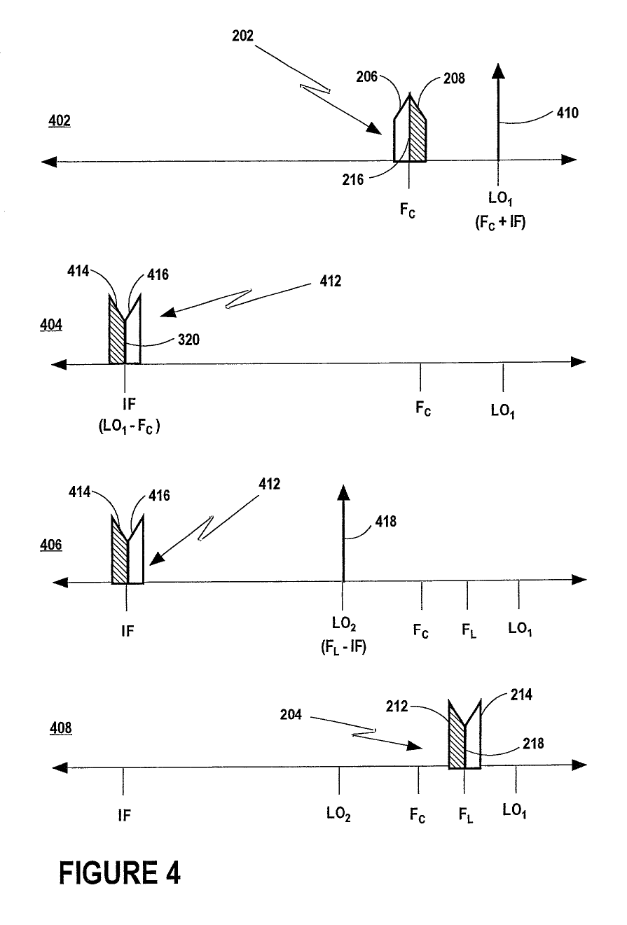

As is explained in further detail with reference to FIGS. 3-4, a coverage signal 202 is frequency shifted from a coverage frequency (F1) to a link frequency (F2) to form a link signal 204 having reversed sidebands (206, 208). An intermediate frequency signal formed by mixing the coverage signal with a first mixing signal mixed is filtered in a band-pass filter and mixed with a second mixing signal to form the link signal 204. The pass band 210 frequency response of the band-pass filter is illustrated by a dashed line 210 in FIG. 2. The first and second mixing signals are chosen such that one and only one of the mixing signals results in high-side injection. The term “high-side injection” refers to the process of shifting an input signal by mixing the input signal with a mixing signal having a frequency that is higher than the input signal. The term “low side injection” refers to a mixing process where the mixing signal is less than the input signal. High-side injection results in a shifted signal having reversed sidebands. In a process involving more than one mixing signal, however, an even number of mixing steps using high side injection results in a shifted signal that does not have reversed sidebands.

FIG. 3 is a graphical representation of a series of states 302-308 of the frequency spectrum 200 depicting the frequency shifting of the coverage signal to the link signal in accordance with the exemplary embodiment of the invention where the frequency of the second mixing signal is higher than the link frequency. The mixing signals are identified using the notation of LO₁ and LO₂ in accordance with known techniques in the art for identifying mixing signals. Although the notation often relates to local oscillators generating a local oscillator signal having local oscillator frequency, those skilled in the art will recognize that the mixing signals may be generated or obtaining using any of several ways and the use of the term LO does not in anyway limit the mixing signals to signals generated by local oscillators. State 302 shows the coverage signal and a first mixing signal 310. In the exemplary embodiment, the first mixing signal is produced by a local oscillator and has a frequency of LO1. Where low side injection is used for the first mixing signal, LO1 is equal to the sum of the coverage frequency (F_{c}) and the desired intermediate frequency (IF).

At state 304, the first mixing signal and the coverage signal are mixed to form the intermediate frequency (IF) signal 312 at the IF frequency where the IF is equal to F_{c}−LO1. An IF lower-sideband 314 corresponds to the coverage signal lower-sideband 206 and an IF upper-sideband 316 corresponds to the coverage signal upper-sideband 208. As shown in state 304 of FIG. 3, the sidebands 314, 316 of the IF signal 312 are not reversed relative to coverage signal sidebands 206, 208.

As shown in state 306, the second mixing signal 318 had a frequency of L_{O2} that is equal to the sum of the link frequency (F_{L}) and the IF. The second mixing signal 318 is mixed with the filtered IF signal to form the link signal 204 at the link frequency, F_{L}. The link frequency, F_{L}, is equal to L_{O2}−IF. The link signal upper-sideband 214 corresponds to the coverage signal lower-sideband 206 and the link signal lower-sideband 212 corresponds to the coverage signal upper-sideband 208. Signal filtering is applied to reduced the effects of an image signal at an image frequency produced during the mixing process.

FIG. 4 is a graphical representation of a series of states 402-408 of the frequency spectrum 200 depicting the frequency shifting of the coverage signal 202 to the link frequency 216 to form the link signal 204 in accordance with the exemplary embodiment of the invention where the frequency (LO₁ ) of the first mixing signal 410 is higher than the link frequency 216. As shown in state 402, the first mixing signal 410 has a frequency of LO₁ equal to the sum of the coverage frequency (F_{c}) and the IF. When the first mixing signal 410 is mixed with the coverage signal 202, an IF signal 412 is formed at a frequency equal to the difference between the center frequency (216) of the coverage signal 202 and the first mixing signal 410 (IF=LO₁−F_{c}). The resulting IF signal 412 shown in state 404 has reversed sidebands as compared to the coverage signal 202. Since high side injection is used for the first mixing procedure, the IF signal 412 has an IF upper-sideband that corresponds to the coverage signal lower-sideband 206. An IF lower-sideband 414 of the IF signal 412 corresponds to the coverage signal upper-sideband 208.

The IF band pass filter reduced the amplitude of the signals outside of the IF bandwidth such as the image signal spurious signals and other undesired signals. The IF signal 412 is mixed with a second mixing signal 418 having a frequency (LO₂) equal to the difference of the link frequency (F_{L}) and the IF. The frequency (LO₂) of the second mixing signal is therefore less than the link frequency (F_{L}) resulting in low-side injection. Accordingly, the link signal 204 also has reversed sidebands (212, 214).

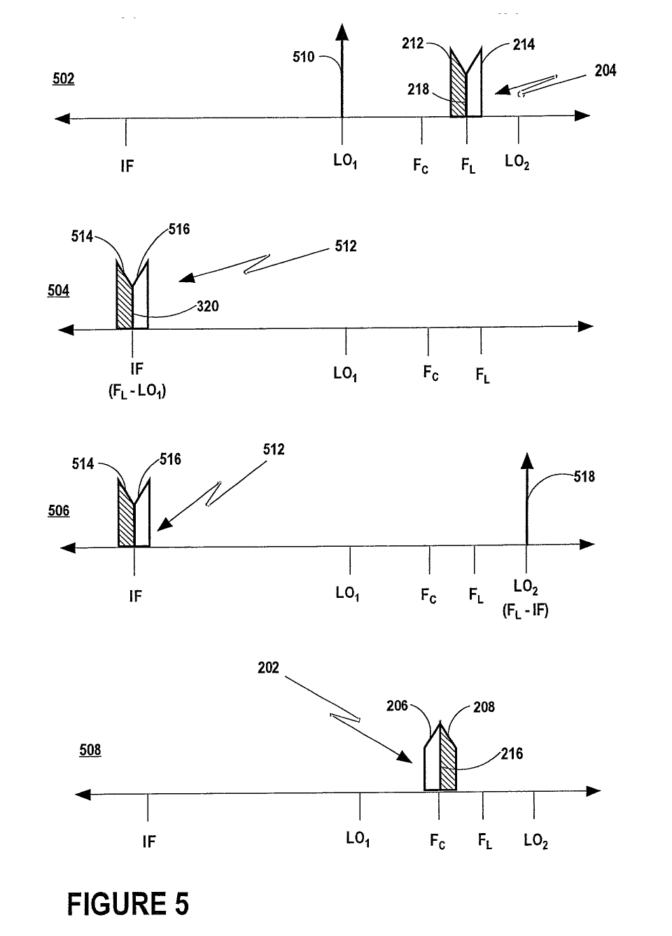

FIG. 5 is a graphical representation of a series of states 502-508 of the frequency spectrum 200 depicting the frequency shifting of the link signal 204 to the coverage frequency 216 to form the coverage signal 202 in accordance with the exemplary embodiment of the invention where the frequency (LO₁ ) of the first mixing signal 510 is lower than the link frequency 218. Frequency shifting of a link signal 204 to a coverage signal 202 is performed in the distribution station and the interface station in the exemplary embodiment. The distribution station forms a downstream coverage signal corresponding to a downstream link signal received from the base station. The interface station of the base station forms an upstream coverage signal from the upstream link signal. As explained above, the link signals are transmitted with reversed sidebands as compared to the coverage signals. The link signal is shifted to the coverage frequency to form a coverage signal having reversed sidebands as compared to the link signal. Therefore, if the link signal is an upstream link signal transmitted from the distribution station, the interface station of the base station frequency shifts the upstream link signal to form an upstream coverage signal having a sideband form that allows the upstream coverage signal to be received by the cellular base station. If the link signal is a downstream link signal transmitted from the base station, the distribution station frequency shifts the downstream link signal to form a downstream coverage signal having a sideband form that allows the downstream coverage signal to be received by the mobile stations.

As shown in state 502, the first mixing signal having a frequency of LO1 can be used to perform low side injection. The mixing signal 510 is mixed with the link signal 204 to form the IF signal 512 at the IF frequency 320 which is equal to the difference between the link frequency 218 and the first mixing frequency 510 (FL−LO1). As illustrated in state 504 of FIG. 5, the resulting IF signal 512 has reversed sidebands 514, 516 and has a center frequency equal to the IF frequency 320.

Referring to state 506, the second mixing signal 518 has a second mixing frequency higher than the coverage frequency (F_{c}) 216. Therefore, high side injection is performed to shift the IF signal 512.

As shown in state 508, the resulting coverage signal 202 has a center frequency 216 of Fc and has sidebands 206, 208 that are reversed compared to the link signal 204. If the link signal 204 is an upstream link signal transmitted from the distribution station, the upstream coverage signal produced by the interface station can be received by the cellular base station. If the link signal is a downstream link signal transmitted from the base station, the downstream coverage signal produced by the distribution station can be received by a mobile station.

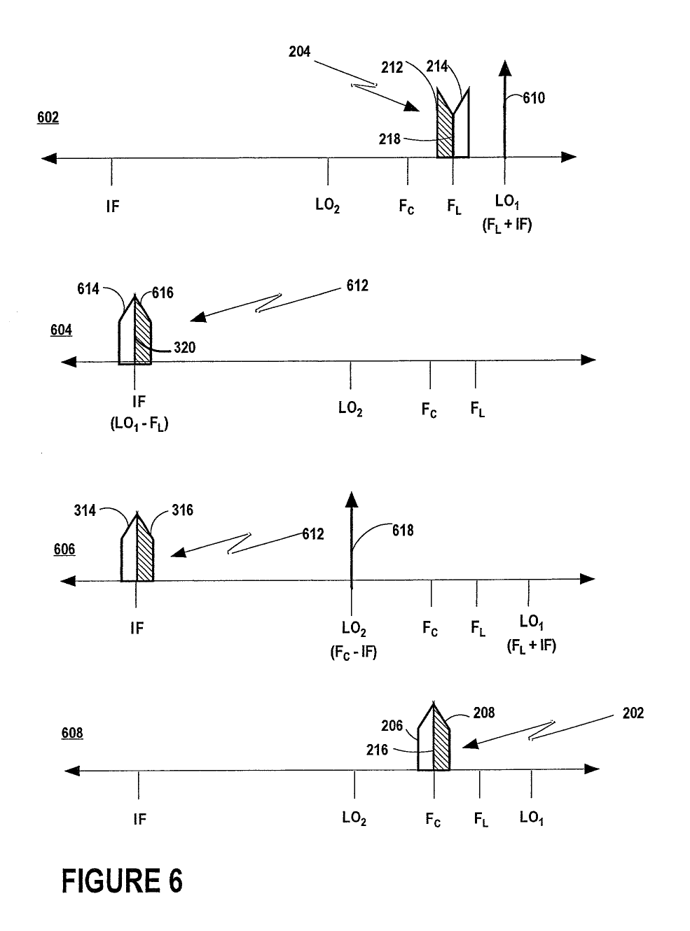

FIG. 6 is a graphical representation of a series of states 602-608 of the frequency spectrum 200 depicting the frequency shifting of the link signal 204 to the coverage frequency 216 to form the coverage signal 202 in accordance with the exemplary embodiment of the invention where the frequency (LO₁ ) of the first mixing signal 610 is greater than the link frequency 218.

As shown in state 602, the first mixing signal having a frequency of LO1 can be used to perform high side injection. The mixing signal 610 is mixed with the link signal 204 to form the IF signal 612 at the IF frequency 320 which is equal to the difference between the first mixing frequency 610 and the link frequency 218 (LO1−FL). As illustrated in state 604 of FIG. 6, the resulting IF signal 612 has reversed sidebands 614, 616 compared to the link signal 218 but not to the coverage signal used to form the link signal and has a center frequency equal to the IF frequency 320.

Referring to state 606, the second mixing signal 618 has a second mixing frequency lower than the coverage frequency (Fc) 216. Therefore, low side injection is performed to shift the IF signal 612.

As shown in state 608, the resulting coverage signal 202 has a center frequency 216 of Fc and has sidebands 206, 208 that are reversed compared to the link signal 204. If the link signal 204 is an upstream link signal transmitted from the distribution station, the upstream coverage signal produced by the interface station can be received by the cellular base station. If the link signal is a downstream link signal transmitted from the base station, the downstream coverage signal produced by the distribution station can be received by a mobile station.

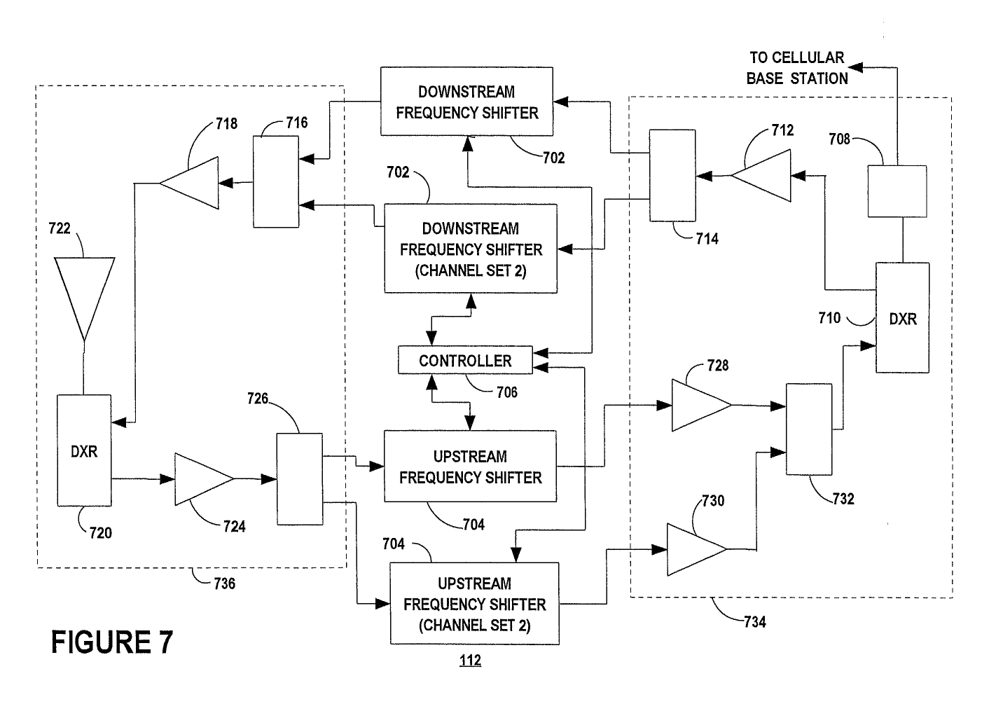

FIG. 7 is a block diagram of a interface station 112 in accordance with the exemplary embodiment of the invention. The functional blocks in FIG. 7 may be implemented using any combination of hardware, software or firmware. The interface station 112 in the exemplary embodiment is configured to receive two downstream coverage signals at two different frequencies and to transmit corresponding downstream link signals at two link frequencies. FIG. 7 illustrates blocks for receiving and processing signals at two frequencies. Similar functional blocks for processing other signals at other frequencies can be connected to the blocks shown using splitters and combiners. The teachings herein can be expanded to implement a interface station 112 capable of processing any number of signals or channels.

The interface station 112 includes at least a base communication interface 734 for communicating with the cellular base station 114 and a link communication interface 736 for communicating with the distribution station 104. The functions of the communication interfaces 734-736 can be implemented using any combination of software, hardware and firmware. Exemplary implementations are discussed below. The blocks representing the communication interfaces 734-736 are shown using dashed lines to indicate that each of the communication interfaces (734-736) may include other functional blocks or portions of function blocks shown in FIG. 7. For example, some or all of the communication interfaces 734-736 may include portions of the frequency shifters 702, 704 or the controller 706.

The base interface station 112 includes a downstream frequency shifter 702 for each downstream channel to frequency shift an incoming downstream coverage signal to the downstream distribution frequency. An upstream frequency shifter 704 frequency shifts the upstream distribution signal to the upstream coverage frequency for each upstream channel.

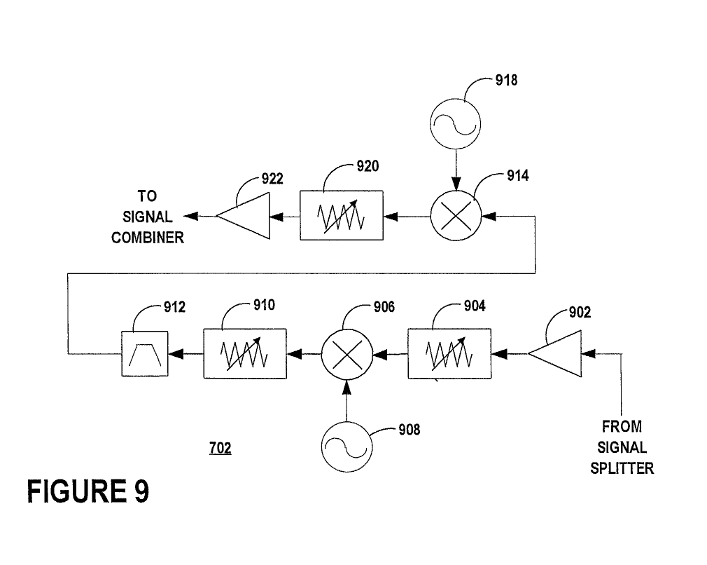

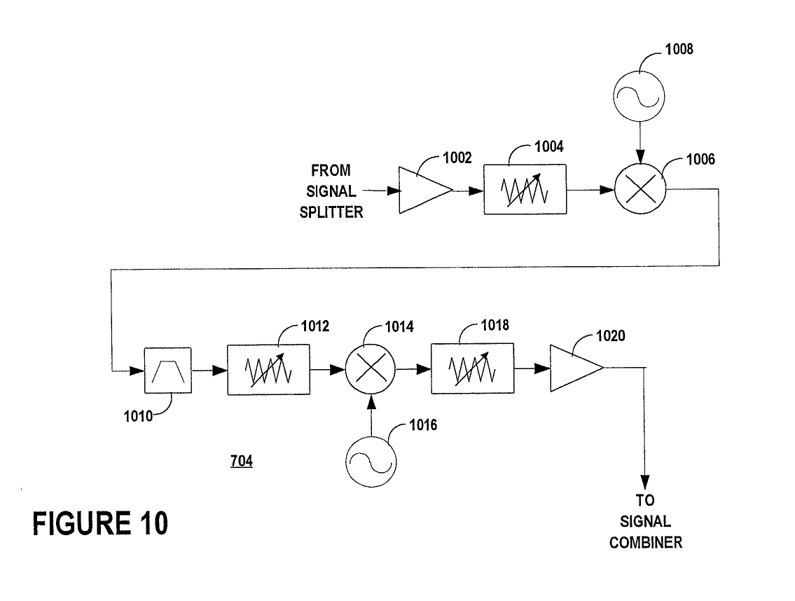

A controller 706 provides control signals to the frequency shifters 702, 704 as described below in reference to FIG. 9 and FIG. 10. In the exemplary embodiment, the controller 706 is a PC104 a microprocessor model number available from the JUMPtec® Industrielle Computertechnik AG company. The controller 706, however, may be any type of micro-processor, computer processor, processor arrangement or processor combination suitable for implementing the functionality discussed herein. Software running on the controller 706 provides the various control functions and facilitates the overall functionality of the base interface station 112.

A downstream coverage signal transmitted from the base station 102 at the downstream coverage frequency is received through an power attenuator 708. In the exemplary embodiment, the power attenuator 708 is a impedance network suitable for providing an adequate load to the cellular base station 114 while absorbing the RF power transmitted by the cellular base station 114. In situations where the cellular base station 114 is not co-located with the base interface station 112, the power attenuator 708 may be omitted. Also, the power attenuator may not be needed in some implementations of the interface station 112.

In accordance with known techniques, a coverage duplexer 710 allows for the use of one power attenuator 708 for receiving downstream coverage signals and transmitting upstream coverage signals from and to the cellular base station 114. A Low Noise Amplifier (LNA) 712 amplifies the downstream coverage signal received through the power attenuator 708 and the coverage duplexer 710. Although several types of LNAs can be used to provide the appropriate gain and noise characteristics, an example of a suitable LNA is the LP1500-SOT89, a PHEMT (Pseudomorphic High Electron Mobility Transistor) from Filtronic Solid-State, a division of Filtronic plc. In some implementations, the LNA 712 may not be needed.

The amplified downstream coverage signal is received at the input of a signal splitter 714. In the exemplary embodiment, the signal splitter 714 has two outputs where the signals produced at each output have a power level that is approximately 3 dB lower than the power of the signal at the input. Although the signal splitter 714 may have any number of outputs, a suitable implementation includes a number of outputs in accordance with the number of downstream coverage signals that the base interface station 112 can receive. The signal produced at each output of the signal splitter 714 is received at a downstream frequency shifter 702.

Each downstream frequency shifter 702 in the base interface station 112 shifts signals at a particular frequency of the downstream coverage channel 110 to a downstream link frequency associated with the particular downstream coverage frequency. The various frequencies of the channels are changed in response to control signals provided by the controller 706. In the exemplary embodiment, the frequencies are configured at the time of system installation in accordance with the system frequency allocation scheme. The base interface station 112 can be configured, depending on the particular communication system 100, to dynamically adjust frequencies during operation of the building interface station 112 within the system 100.

The downstream link signals at the output of each downstream frequency shifter 702 are combined in a signal combiner 716 and amplified by an amplifier 718. A link duplexer 720 allows for downstream link signals and upstream link signals to be transmitted and received through the same link antenna 722. Although the link antenna 722 is a vertically polarized dipole antenna in the exemplary embodiment, any suitable antenna can be used.

An LNA 724 amplifies the upstream link signals that are received through the link antenna 722 and the link duplexer 720. As explained above, the upstream link signal has sidebands that are reversed in comparison to the upstream coverage signals. The amplified upstream link signal is received at an input of a signal splitter 726. In the exemplary embodiment, the signal splitter 326 has one output for each of the coverage channels and, therefore, has two outputs. The signal produced at each output of the signal splitter 726 is received at the input of each upstream frequency shifter 704.

Each upstream frequency shifter 704 shifts the upstream link signal from the upstream link frequency to the upstream coverage frequency to form an upstream coverage signal having reversed sidebands compared to the upstream link signal. Therefore, the upstream coverage signals produced at the output of the upstream frequency shifter 704 have the same sideband form as the upstream coverage signals transmitted from the mobile stations. Each resulting upstream coverage signal is amplified in an amplifier 728, 730 and combined with the other resulting upstream signals from the other upstream frequency shifter 704 in the signal combiner 732. The combined signal, which includes upstream coverage signals at two different upstream coverage frequencies is transmitted through the coverage duplexer 710 and the coverage attenuator 708 to the cellular base station 114.

The various functions of the blocks in FIG. 7 may be implemented in hardware, firmware, software or any combination thereof. The functions may be combined or separated in accordance with known techniques. For example, any of the functionality described above may be implemented in a DSP, digital radio or otherwise using software, processors and other components based on these teachings and in accordance with known techniques.

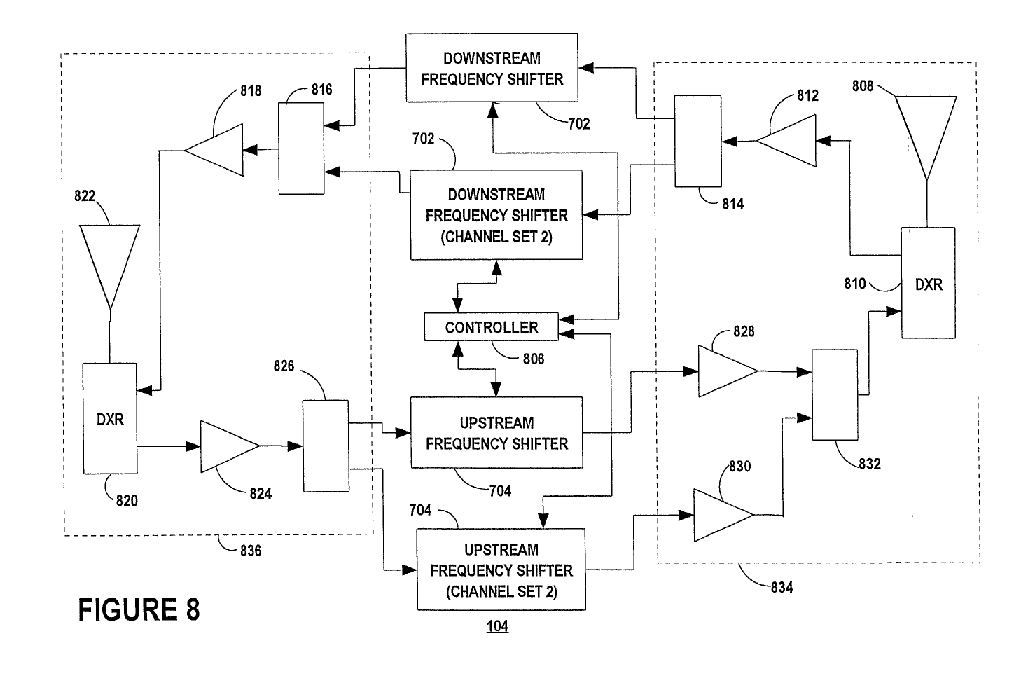

FIG. 8 is a block diagram of a distribution station 104 in accordance with the exemplary embodiment of the invention. The functional blocks in FIG. 8 may be implemented using any combination of hardware, software or firmware. The distribution station 104 in the exemplary embodiment is configured to receive two downstream distribution signals at two different frequencies and to transmit corresponding downstream coverage signals at two coverage frequencies. FIG. 8 illustrates blocks for receiving signals on two channels. The teachings herein can be expanded to implement a distribution station 104 capable of processing any number of channels.

The distribution station 104 includes at least a link communication interface 834 for communicating through the wireless link channel 108 and a coverage communication interface 836 for communicating through the wireless coverage channel 110. The functions of the communication interfaces 834, 836 can be implemented using any combination of software, hardware and firmware. Exemplary implementations are discussed below. The blocks representing the communication interfaces 834, 836 are shown using dashed lines to indicate that each of the communication interfaces (834, 836) may include other functional blocks or portions of function blocks shown in FIG. 8. For example, either or both of the communication interfaces 834, 836 may include portions of the frequency shifters 702, 704, or the controller 806.

The distribution station 104 includes a downstream frequency shifter 702 for each channel to frequency shift an incoming downstream link signal from the downstream link frequency to the downstream coverage frequency to form a coverage signal having sidebands that allows the reception of the downstream coverage signal by a mobile station 106. An upstream frequency shifter 704 for each coverage channel frequency shifts the upstream coverage signal from the upstream coverage frequency to the upstream link frequency to form the upstream link signal having reversed sidebands.

A controller 806 provides control signals to the frequency shifters 702, 704 as described below in reference to FIG. 9 and FIG. 10. In the exemplary embodiment, the controller 806 is a PC104 microprocessor available from JUMPtec® Industrielle Computertechnik AG. The controller 806, however, may be any type of micro-processor, computer processor, processor arrangement or processor combination suitable for implementing the functionality discussed herein. Software running on the controller 806 provides the various control functions and facilitates the overall functionality of the distribution station 104.

A downstream link signal transmitted from the interface station 112 at the downstream link signal is received through the link antenna 808. In the exemplary embodiment, the link antenna 808 is a directional antenna aligned to maximize the signal-to-noise ratio of signals transmitted between the interface station 112 and the distribution station 104. Other types of antennas may be used and, in certain instances recognized by those skilled in the art, other types of antennas may be preferred.

In accordance with known techniques, a duplexer 810 allows for the use of a single link antenna 808 for receiving downstream link signals and transmitting upstream link signals. A Low Noise Amplifier (LNA) 812 amplifies the downstream link signal received through the link antenna 808 and the duplexer 810. Although several types of LNAs 412 can be used to provide the appropriate gain and noise characteristics, an example of a suitable LNA 812 is the LP1500-SOT89 PHEMT (Pseudomorphic High Electron Mobility Transistor) from Filtronic Solid-State, a division of Filtronic plc.

The amplified downstream link signal is received at the input of a signal splitter 814. In the exemplary embodiment, the signal splitter 814 has two outputs where the signals produced at each output have a power level that is approximately 3 dB lower than the power of the signal at the input. Although the signal splitter 814 may have any number of outputs, a suitable implementation includes a number of outputs in accordance with the number of channels that the distribution station 104 can receive. The signal at each output is received at a downstream frequency shifter 702.

As discussed in further detail below with reference to FIG. 9, the downstream frequency shifter 702 shifts the signal received at its input to a downstream coverage frequency and reverses the sidebands. Each downstream frequency shifter 702 in the distribution station 104 shifts signals at the particular frequency of the wireless link channel 108 to a downstream coverage frequency associated with the particular link frequency. In the exemplary embodiment, therefore, the two downstream frequency shifters 702 shift signals at two downstream link frequencies within upstream frequency bandwidth to two downstream coverage frequencies within the wireless coverage channel 110. Although the various frequencies of the channels are changed in response to control signals generated by the controller 806, the frequencies are configured at the time of system 100 installation in accordance with the system frequency allocation scheme in the exemplary embodiment. A suitable control technique includes the use of a wireless modem system (not shown) connected to the controller 806 for channel and frequency management. The distribution station 104 can be configured, depending on the particular communication system 100, to dynamically adjust frequencies during operation of the distribution station 104 within the system 100.

The downstream coverage signals at the output of each downstream frequency shifter 802 are combined in a signal combiner 816 and amplified by an amplifier 818. A coverage duplexer 820 allows for downstream coverage signals and upstream coverage signals to be transmitted and received through the same coverage antenna 822. The coverage antenna 822 is a vertically polarized directional antenna, such as the S1857AMP10SMF antenna from Cushcraft Communications. The coverage antenna 822, however, may have any one of several configurations or polarization depending on the particular communication system 100.

An LNA 824 amplifies the upstream coverage signals that are received through the coverage antenna 822 and the coverage duplexer 820. The amplified upstream coverage signal is received at an input of a signal splitter 826. In the exemplary embodiment, the signal splitter 826 has one output for each of the coverage channels and, therefore, has two outputs. The signals produced at each output of the signal splitter 826 are received at the input of each upstream frequency shifter 704. The upstream frequency shifter 704 shifts the upstream coverage signal from the upstream coverage frequency to the upstream distribution frequency.

As discussed in further detail below with reference to FIG. 10, the upstream frequency shifter 704 shifts the signal received at its input to the upstream link frequency. Each upstream frequency shifter 704 in the distribution station 104 shifts signals at the particular upstream coverage frequency of the wireless coverage channel 110 to an upstream link frequency associated with the particular coverage frequency. In the exemplary embodiment, therefore, the two upstream frequency shifters 704 shift two signals at two upstream coverage frequencies to two upstream link frequencies. The upstream coverage signals at the output of each upstream frequency shifter 704 are amplified by amplifiers 828, 830 and combined in a signal combiner 832 before transmission to the interface station 112 through the duplexer 832 and the link antenna 808.

FIG. 9 is a block diagram of a downstream frequency shifter 702 in accordance with exemplary embodiment of the invention suitable for use within the interface station 112 and the distribution station 104. The downstream signal is received at an input of an amplifier 902 and amplified. In the interface station 112, the downstream signal is a downstream coverage signal received from the cellular base station 114. In the distribution station 104, the downstream signal is a downstream link signal transmitted from the interface station 112 of the base station 102.

A variable attenuator 904 is adjusted to provide the appropriate power level of the downstream signal to a signal mixer 906. Those skilled in the art will recognize the various techniques and devices that can be used to adjust the signal power level into the downstream signal mixer 906.

The first downstream signal mixer 906 mixes the downstream signal with a first mixing signal generated by a first oscillator 908 to shift the downstream signal to the intermediate frequency (IF). As discussed above, either high side or low side injection can be used to shift the signal. When high side injection is used, the IF signal will have reversed sidebands as compared to the received downstream signal. If low side injection is used, the IF signal will not have reversed sidebands compared to the received downstream signal. If the A suitable frequency for the IF is 199 MHz. The IF, however, can be any suitable frequency chosen in accordance with known techniques and will depend on the particular communication system 100 requirements.

The power level is adjusted by another attenuator 910 prior to filtering in a band-pass filter 912. The band-pass filter 912 is a Surface Acoustic Wave (SAW) filter having a bandwidth of approximately 0.2 MHz. Any one of several filters can be used where the selection depends on the type of system 100, bandwidth of the transmitted signal, the required Signal-to-Noise (SNR) ratio of the signals, the isolation required between coverage and distribution frequencies, and several other factors recognized by those skilled in the art. The band-pass filter 912 attenuates signals outside the desired frequency bandwidth and allows the desired signals to pass to the signal mixer 914. The graphical representation of suitable filter response 210 is shown in FIG. 2.

In the exemplary embodiment, the first oscillator 908 is controlled by the controller (706, 806) and the frequency of the mixing signal can be changed to select the desired channel to be received. A suitable configuration of the first mixer 906 and oscillator 908 includes using a voltage controlled oscillator (VCO) and setting the frequency of the mixing signal through a control signal produced by the controller (706, 806).

In the distribution station 104, the filtered IF signal produced at the output of the band-pass filter 912 is mixed with a second mixing signal produced by a second oscillator 918 in the signal mixer 914 to shift the downstream signal to the downstream coverage frequency. The downstream signal is frequency shifted to the downstream link frequency, in the interface station 112, by mixing the IF signal with the appropriate second mixing signal generated by the second oscillator 918. The controller (706, 806) provides control signals to the oscillators 908, 918 to adjust the frequencies of the mixing signals to select the received and transmitted downstream frequencies.

The power level of the downstream signal is adjusted in the attenuator 920 and amplified in the amplifier 922. The level of the signals, however, may be adjusted using any one of several known techniques.

As explained above, either the first signal mixer or the second signal mixer provides high side injection while the other signal mixer provides low side injection. In exemplary interface station 112, the downstream frequency shifter 702 frequency shifts the downstream coverage signal received through the coverage interface 734 to the downstream link frequency 218 to form a downstream link signal 204 having reversed sidebands 212, 214. In the exemplary distribution station 104, the downstream frequency shifter 702, frequency shifts the downstream link signal 204 that has reversed sidebands 212, 214 to the downstream coverage frequency 216 to form the downstream coverage signal (202) having sidebands that are not reversed as compared to the downstream coverage signal received at the interface station 112.

FIG. 10 is a block diagram of an upstream frequency shifter 704 suitable for use in the distribution station 104 and the interface station 112. The upstream signal received at an amplifier 1002 is amplified. A variable attenuator 1004 is adjusted to provide the appropriate power level of the upstream signal to an upstream link mixer 1006. In the exemplary embodiment, analog power control signals generated by the controller (706, 806) are received at a control inputs of the variable attenuators in the upstream frequency shifter 704. Other techniques can be used to provide an upstream signal with the appropriate power level to the upstream signal mixer 1006.

A first oscillator 1008 provides a first mixing signal to the first signal mixer 1006 to shift the signal to the IF. The frequency of the first mixing signal is changed in response to control signals provided by the controller (706, 806) at a control input of the first oscillator 1008. The frequency of the received upstream signal, therefore, is determined by a control signal generated by the controller 706, 806.

The upstream IF signal is filtered by a band-pass filter 1010 before being received at a variable attenuator 1012. The band-pass filter 610 is a Surface Acoustic Wave (SAW) filter having a bandwidth of bandwidth of approximately 0.2 MHz. Any one of several filters, however, can be used where the choice depends on the particular type of communication system 100, bandwidth of the transmitted signal, the required Signal-to-Noise (SNR) ratio of the signals, the isolation required between coverage and link signals. The band-pass filter 1010 attenuates signals outside the desired frequency bandwidth and allows the desired signals to pass to the variable attenuator 1012 and the upstream signal mixer 1014.

In the distribution station 104, an oscillator 1016 provides a second mixing signal to the second signal mixer 1014 to shift the filtered upstream IF signal to the upstream link frequency to form an upstream link signal having reversed sidebands 212, 214. In the interface station 112, the IF signal is mixed with the second mixing signal from the second oscillator 1016 to shift the upstream link signal to the upstream coverage frequency 216 to form the upstream coverage signal 202 having reversed sidebands compared to the upstream link signal and sidebands not reversed as compared to the coverage signal received from the mobile station 106. The frequency of the second mixing signal can be changed by the controller (706, 806) by adjusting a control signal presented to a control input of the oscillators 1008, 1016. The frequencies of the transmitted upstream link signal and the upstream coverage signal, therefore, are determined by control signals generated by the controller 706, 806 in the exemplary embodiment. The power level of the upstream signal is adjusted by a variable attenuator 1018 and amplified by an amplifier 1020.

As explained above, either the first signal mixer or the second signal mixer provides high side injection while the other signal mixer provides low side injection. In the exemplary interface station 112, the upstream frequency shifter 704 shifts the upstream link signal that reversed sidebands to the coverage frequency 216 to form a coverage signal 202 that does not have reversed sidebands as compared to the coverage signal 202 transmitted from the mobile station 106.

The various functions of the blocks in FIG. 9 and FIG. 10 may be implemented in hardware, firmware, software or any combination thereof. The functions may be combined or separated in accordance with known techniques. For example, any of the functionality described above may be implemented in a DSP, digital radio or otherwise using software, processors and other components based on these teachings and in accordance with known techniques. Further, the upstream frequency shifter and the downstream frequency shifter may implemented as single integrated circuit such as an Application Specific Integrated Circuit (ASIC), using discrete components or any combination thereof.

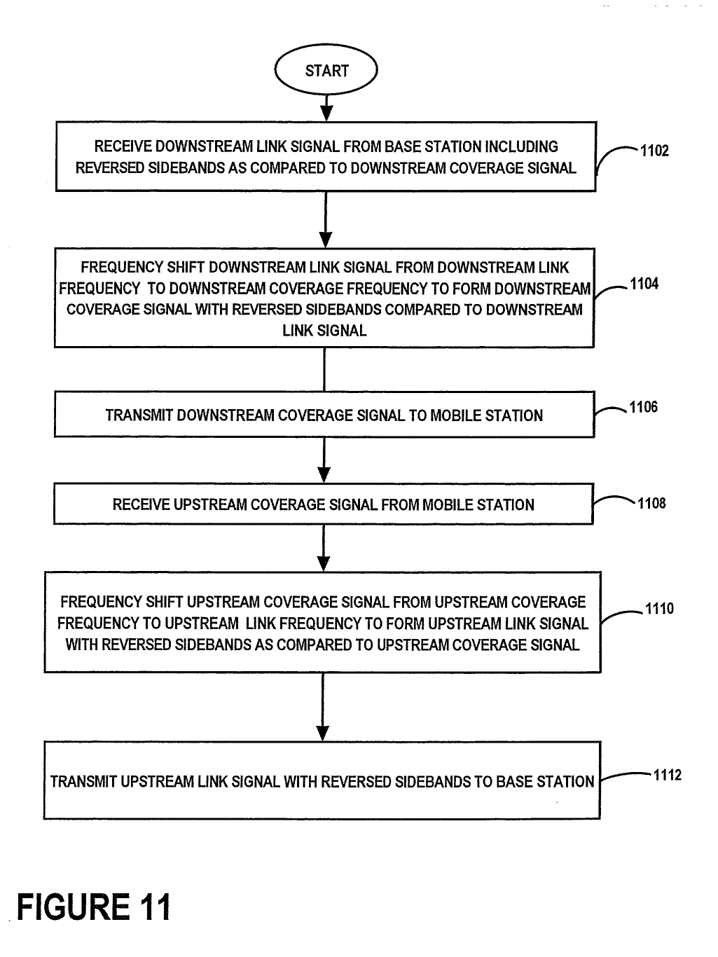

FIG. 11 is a flow chart of a method of communicating with the base station 102 and with the mobile station 106 in accordance with the exemplary embodiment of the invention. Although the method is performed in a distribution station 104 in the exemplary embodiment, the method can wholly or partially be performed by other components of the system 100. Software code running on the processor or controller 806 within the distribution station 104 directs the execution of the steps of the method in addition to facilitating the overall functionality of the distribution station 104, and other functions. The method, however, may be performed using any combination of software, hardware, or firmware.

At step 1102, the distribution station 104 receives a downstream link signal 204 from the base station 102. As explained above, the link signal 204 shown in FIGS. 2 through 6 can represent either a downstream link signal or an upstream link signal. In order to avoid confusion, however, the downstream link signal and upstream link signal do not include the “204” reference number. The downstream link signal has reversed sidebands where a link signal upper-sideband corresponds to the coverage signal lower-sideband and the link signal lower-sideband corresponds to the coverage signal upper-sideband. The signal is received through the link interface 834 in the exemplary embodiment.

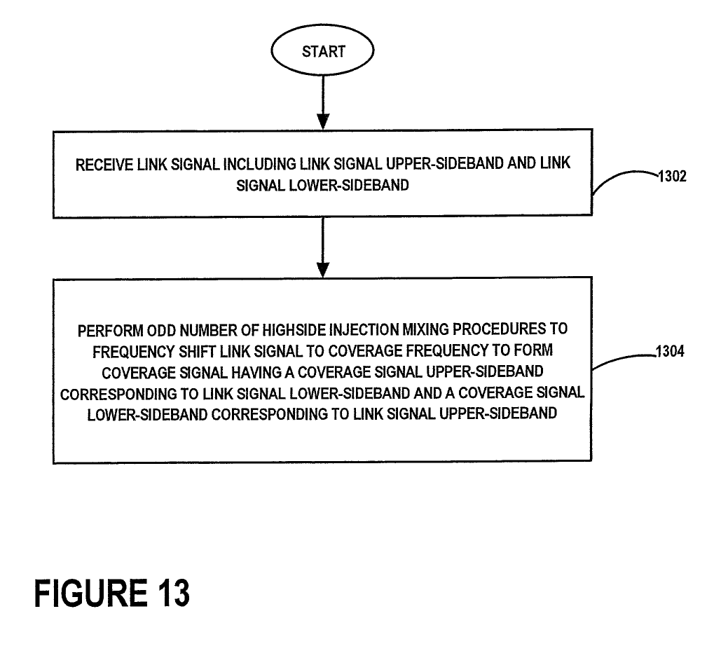

At step 1104, the downstream link signal is frequency shifted from the downstream link frequency 208 to the downstream coverage frequency to form the downstream coverage signal having reversed sidebands as compared to the link signal. In the exemplary embodiment, the downstream link signal is shifted to the IF, and shifted from the IF to the downstream coverage frequency using oscillators, mixers and other components under the control of the controller within the distribution station 104. An exemplary method of performing step 1104 is discussed below with reference to FIG. 13.

At step 1106, the distribution station 104 transmits the downstream coverage signal to the mobile station 106. The coverage interface 838 transmits the downstream coverage signal at the downstream coverage frequency through the wireless coverage channel 110. Components within the coverage interface 838 form a transmitter that transmits the downstream coverage signal. The downstream coverage signal is received by a mobile station 106 using conventional equipment and techniques since the sidebands of the downstream coverage signal are not reversed.

At step 1108, the distribution station 104 receives an upstream coverage signal from the mobile station 106. The coverage interface 838 receives the upstream coverage signal at the upstream coverage frequency.

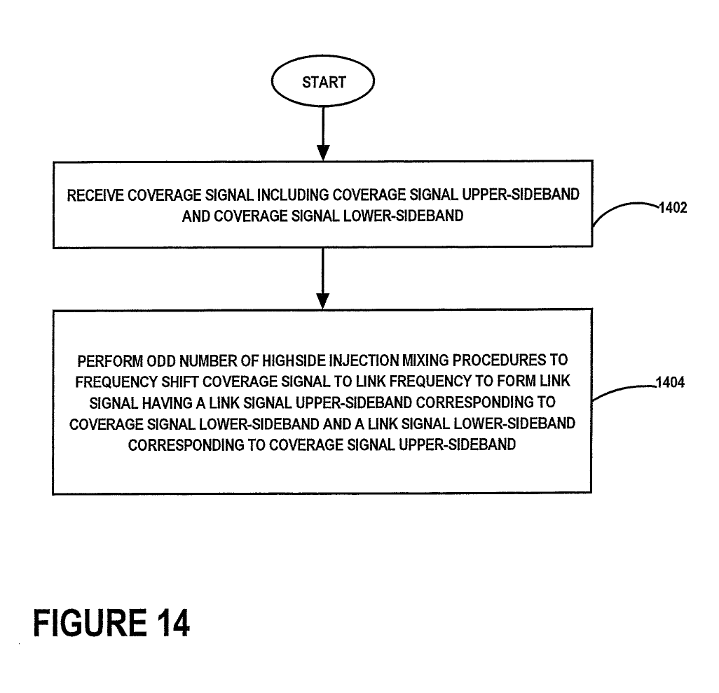

At step 1110, the upstream coverage signal is frequency shifted from the upstream coverage frequency to the upstream link frequency to form an upstream link signal with reversed sidebands as compared to the upstream coverage signal. An exemplary method of performing step 1110 is discussed below with reference to FIG. 14.

At step 1112, the upstream link signal is transmitted to the base station. The link interface 834 transmits the upstream link signal with reversed sidebands through the wireless link channel 108. Components within the link interface 834 form a transmitter that transmits the upstream link signal to the base station 102. The upstream link signal can not be received by a distribution station since the sidebands are reversed.

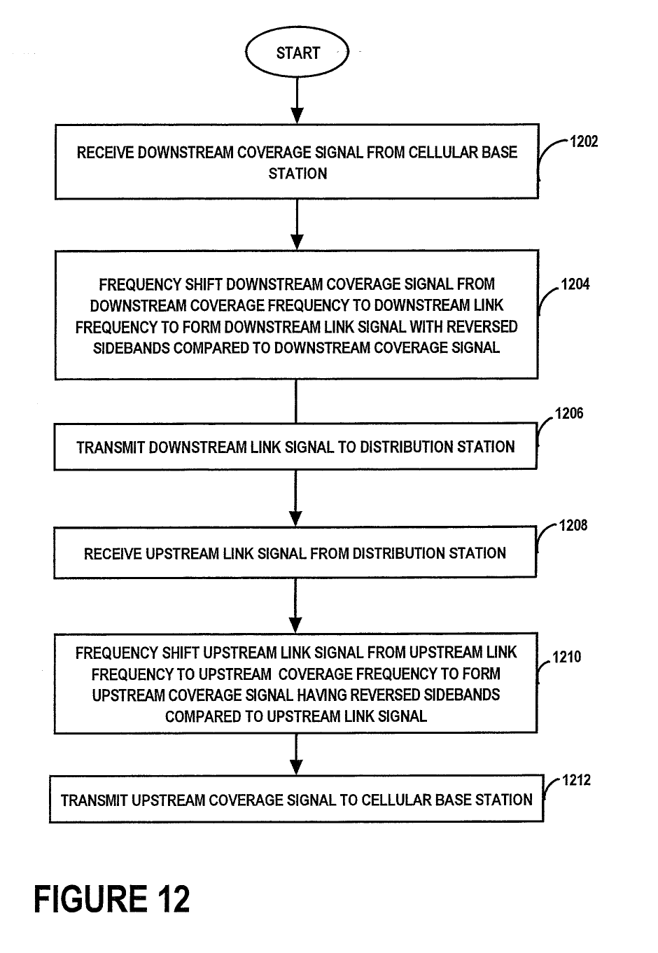

FIG. 12 is flow chart of a method of communicating between a cellular base station 114 and a distribution station 104 in accordance with the exemplary embodiment of the invention. Although the method is performed in the interface station 112 in the exemplary embodiment, the method can wholly or partially be performed by other components of the system 100. Software code running on the processor or controller 706 within the interface station 112 directs the execution of the steps of the method in addition to facilitating the overall functionality of the interface station 112, and other functions. The method, however, maybe performed using any combination of software, hardware, or firmware.

At step 1202, the interface station 112 receives a downstream coverage signal from the cellular base station 114. In the exemplary embodiment, communication signals are exchanged between the cellular base station and the interface station through a coaxial cable. Components within the interface station 112 form a receiver that receives the downstream coverage signal.

At step 1204, the downstream coverage signal is frequency shifted from the downstream coverage frequency to the downstream link frequency to form the downstream link signal with reversed sidebands. An exemplary method of performing step 1204 is discussed with reference to FIG. 14.

At step 1106, the interface station 112 transmits the downstream link signal to the distribution station 104. The link interface 736 transmits the downstream link signal with reversed sidebands at the downstream link frequency 208 through the wireless link channel 108. Components within the link interface 736 form a transmitter that transmits the downstream link signal. As explained above, mobile stations 106 can not receive the downstream link signal because the sidebands are reversed.

At step 1208, the interface station 112 receives the upstream link signal from the distribution station 104. The link interface 736 receives the upstream link signal having reversed sidebands as compared to the corresponding upstream coverage signal transmitted from the mobile station 106.

At step 1210, the upstream link signal is frequency shifted from the upstream link frequency to the upstream coverage frequency to form the upstream coverage signal with reversed sidebands as compared to the upstream link signal. The upstream coverage signal, therefore, does not have reversed sidebands as compared to the signal transmitted from the mobile station 106 and can be received with conventional equipment and techniques. An exemplary method of performing step 1210 is discussed with reference to FIG. 13.

At step 1212, the upstream coverage signal is transmitted to the cellular base station 114. Components within the base interface 734 form a transmitter that transmits the upstream coverage signal to the cellular base station 114 through the coaxial cable.

FIG. 13 is a flow chart of a method of shifting a link signal to a coverage signal in accordance with the exemplary embodiment of the invention. The method can be used to shift the upstream link signal to an upstream coverage signal and, therefore, provides and a suitable method for performing step 1210 in FIG. 12. Further, the exemplary method can be used to shift a downstream link signal to a downstream coverage signal and therefore, provides an exemplary method for performing step 1104 in FIG. 11.

At step 1302, the link signal is received at the frequency shifter 702, 704. The link signal has a link signal upper-sideband and a link signal lower-sideband.

At step 1304, an odd number of high side injection mixing procedures are performed to frequency shift the link signal to the coverage frequency to form a coverage signal having a coverage signal upper-sideband corresponding to the link signal lower-sideband and a coverage signal lower-sideband corresponding to the link signal upper-sideband. One suitable of shifting the link signal includes mixing the signal to the intermediate frequency (IF) using either high side or low side injection and then frequency shifting the IF signal to the coverage signal using high side injection if low side injection was used to shift the link signal to the IF and using low side injection if high side injection was used to shift the link signal to the IF.

FIG. 14 is a flow chart of a method of shifting a coverage signal to a link signal in accordance with the exemplary embodiment of the invention. The method can be used to shift the upstream coverage signal to an upstream link signal and, therefore, provides and a suitable method for performing step 1110 in FIG. 11. Further, the exemplary method can be used to shift a downstream coverage signal to a downstream link signal and, therefore, provides an exemplary method for performing step 1204 in FIG. 12.

At step 1402, the coverage signal is received at the frequency shifter 702, 704. The coverage signal has a coverage signal upper-sideband and a coverage signal lower-sideband.

At step 1404, an odd number of high side injection mixing procedures are performed to frequency shift the coverage signal to the link frequency to form a link signal having a link signal upper-sideband corresponding to the coverage signal lower-sideband and a link signal lower-sideband corresponding to the coverage signal upper-sideband. One suitable method of shifting the coverage signal includes mixing the signal to the intermediate frequency (IF) using either high side or low side injection and then frequency shifting the IF signal to the link signal using high side injection if low side injection was used to shift the coverage signal to the IF and using low side injection if high side injection was used to shift the coverage signal to the IF.

In the exemplary embodiment, therefore, link signals forming a wireless backhaul in a communication system are transmitted with reversed sidebands as compared to coverage signals used by the mobile stations 106. Link signal include an upper-sideband corresponding to a lower-sideband of a coverage signals and a lower-sideband corresponding to an upper-sideband of the coverage signal. Accordingly, the mobile stations 106 can not communicate directly with the interface station 112 or the base station 102 on the link channels 110.

Clearly, other embodiments and modifications of this invention will occur readily to those of ordinary skill in the art in view of these teachings. Therefore, this invention is to be limited only by following claims, which include all such embodiments and modifications when viewed in conjunction with the above specification and accompanying drawings.

I claim:

1. A method comprising:
receiving, at a coverage frequency, a coverage signal having a coverage signal upper-sideband and a coverage signal lower-sideband;
forming a link signal at a link frequency, the link signal comprising a link signal upper-sideband corresponding to the coverage signal lower-sideband and a link signal lower-sideband corresponding to the coverage signal upper-sideband.

2. A method in accordance with claim 1, wherein the forming comprises:
performing an odd number of high side injection mixing procedures to frequency shift the link coverage signal to the link frequency.

3. A method in accordance with claim 2, wherein the performing comprises:
mixing the coverage signal with a first mixing signal to form an intermediate frequency (IF) signal; and
mixing the IF signal with a second mixing signal to form the link signal.

4. A method in accordance with claim 3, wherein:
the first mixing signal has a first mixing frequency greater than the coverage frequency; and
the second mixing signal has a second mixing frequency less than the link frequency.

5. A method in accordance with claim 3, wherein:
the first mixing signal has a first mixing frequency less than the coverage frequency; and
the second mixing signal has a second mixing frequency greater than the link frequency.

6. A method of forming a link signal at a link frequency from a coverage signal at a coverage frequency, the coverage signal comprising a coverage signal lower-sideband and a coverage signal upper-sideband, the method comprising:
inverting the coverage signal lower-sideband and the coverage signal upper-sideband to form the link signal comprising a link signal upper-sideband corresponding to the coverage signal lower-sideband and a link signal lower-sideband corresponding to the coverage signal upper-sideband.

7. A method in accordance with claim 6 wherein the inverting comprises:
frequency shifting the coverage signal from the coverage frequency to the link frequency.

8. A method in accordance with claim 7, wherein the frequency shifting comprises:
frequency mixing the coverage signal with a first mixing signal at a first mixing frequency to form an intermediate frequency signal at an intermediate frequency;
frequency mixing the intermediate frequency signal with a second mixing signal at a second mixing frequency greater than the link frequency if the first mixing frequency is less than coverage frequency and less than the link frequency if the first mixing frequency is greater than the coverage frequency.

9. A method in accordance with claim 7, wherein the frequency shifting further comprises filtering the intermediate frequency signal.

10. A method in accordance with claim 7, wherein the frequency shifting further comprises:
performing an odd number of high side injection frequency mixing procedures.

11. A method comprising:
receiving a coverage signal at coverage frequency, the coverage signal comprising a coverage signal lower-sideband and a coverage signal upper-sideband;
inverting a coverage signal lower-sideband and the coverage signal upper-sideband to form a link signal at a link frequency, the link signal comprising a link signal upper-sideband corresponding to the coverage signal lower-sideband and a link signal lower-sideband corresponding to the coverage signal upper-sideband; and
transmitting the link signal.

12. A method in accordance with claim 11, wherein the receiving comprises:
receiving a downstream coverage signal from a cellular base station.

13. A method in accordance with claim 12, wherein the transmitting comprises:
transmitting a downstream link signal through a wireless link channel to a distribution station configured to transmit a corresponding coverage signal to a mobile station.

14. A method in accordance with claim 11, wherein receiving the coverage signal comprises:
receiving an upstream coverage signal through a wireless coverage channel.

15. A method in accordance with claim 14, wherein the transmitting the link signal comprises:
transmitting an upstream link signal to a cellular base station.

16. A method comprising:
receiving an upstream coverage signal at an upstream coverage frequency through a wireless coverage channel from one or more mobile stations, the upstream coverage signal comprising a coverage signal upper-sideband and a coverage signal lower-sideband;
frequency shifting the upstream coverage signal from the upstream coverage frequency to the an upstream link frequency to invert the upstream coverage signal lower-sideband and the upstream coverage signal upper-sideband to form an upstream link signal at an upstream link frequency, the upstream link signal comprising an upstream link signal upper-sideband corresponding to the upstream coverage signal lower-sideband and an upstream link signal lower-sideband corresponding to the upstream coverage signal upper-sideband; and
transmitting the upstream link signal to a base station through a wireless link channel.

17. A method in accordance with claim 16, wherein the frequency shifting comprises:
frequency mixing the upstream coverage signal with a first mixing signal at a first mixing frequency to form an intermediate frequency signal at an intermediate frequency;
frequency mixing the intermediate frequency signal with a second mixing signal at a second mixing frequency greater than the upstream link frequency if the first mixing frequency is less than the upstream coverage frequency and less than the upstream link frequency if the first mixing frequency is greater than the upstream coverage frequency.

18. A method in accordance with claim 16, wherein the frequency shifting further comprises filtering the intermediate frequency signal.

19. A method in accordance with claim 16, wherein the frequency shifting further comprises:
performing an odd number of high side injection frequency mixing procedures.

20. A method in accordance with claim 16, further comprising:
receiving a downstream link signal at a downstream link frequency through the wireless link channel from the base station, the downstream link signal comprising a link signal upper-sideband and a link signal lower-sideband;
frequency shifting the downstream link signal from the downstream link frequency to a downstream coverage frequency to invert the downstream link signal lower-sideband and the downstream link signal upper-sideband to form a downstream coverage signal at a downstream coverage frequency, the downstream coverage signal comprising a downstream coverage signal upper-sideband corresponding to the downstream link signal lower-sideband and a downstream coverage signal lower-sideband corresponding to the downstream link signal upper-sideband; and
transmitting the downstream coverage signal to the mobile station through the wireless coverage channel.

21. A method in accordance with claim 17, wherein the frequency shifting the downstream link signal comprises:
frequency mixing the downstream link signal with a third mixing signal at a third mixing frequency to form another intermediate frequency signal at the intermediate frequency;
frequency mixing the another intermediate frequency signal with a fourth mixing signal at a fourth mixing frequency greater than the downstream link frequency if the third mixing frequency is less than the downstream link frequency and less than the downstream coverage frequency if the third mixing frequency is greater than the downstream link frequency.

22. A method in accordance with claim 21, wherein the frequency shifting the downstream link signal further comprises filtering the intermediate frequency signal.

23. A method in accordance with claim 21, wherein the frequency shifting the downstream link signal further comprises:
performing an odd number of high side injection frequency mixing procedures.

24. A method comprising:
receiving a downstream coverage signal at a downstream coverage frequency;
frequency mixing the downstream coverage signal with a first mixing signal having a first mixing frequency to form an intermediate frequency signal; and
forming a downstream link signal by frequency mixing the intermediate frequency signal with a second mixing signal having a second mixing frequency less than the link frequency if the first mixing signal is greater than the coverage frequency and greater than the link frequency if the second mixing frequency is less than the coverage frequency.

25. A method comprising:
receiving a downstream coverage signal at a downstream coverage frequency from a cellular base station;
forming an intermediate frequency signal having an intermediate frequency by frequency mixing the downstream coverage signal with a first mixing signal having a first mixing frequency equal to the difference between the downstream coverage signal and the intermediate frequency;
forming a downstream link signal having a downstream link frequency by frequency mixing the intermediate frequency signal with a second mixing signal having a second mixing frequency equal to the sum of the intermediate frequency and the downstream link frequency; and
transmitting the downstream link signal to a distribution station through a wireless link channel.

26. An apparatus comprising:
a first interface configured to receive a coverage signal at a coverage frequency, the coverage signal having a coverage signal lower-sideband and a coverage upper-sideband; and
a second interface configured to transmit a link signal at a link frequency and having a link signal upper-sideband corresponding to the coverage signal lower-sideband and a link signal lower-sideband corresponding to the coverage signal upper-sideband.

27. An apparatus in accordance with claim 26, further comprising:
a first mixer for frequency mixing the coverage signal with a first mixing signal having a first mixing frequency to form an intermediate frequency signal; and
a second mixer for frequency mixing the intermediate frequency signal with a second mixing signal having a second mixing frequency less than the link frequency if the first mixing signal is greater than the coverage frequency and greater than the link frequency if the second mixing frequency is less than the coverage frequency to form the link signal.

28. An apparatus comprising:
a first interface configured to receive a link signal at a link frequency, the link signal having a link signal lower-sideband and a link signal upper-sideband; and
a second interface configured to transmit a coverage signal at a coverage frequency and having a coverage signal upper-sideband corresponding to the link signal lower-sideband and a coverage signal lower-sideband corresponding to the link signal upper-sideband.

29. An apparatus in accordance with claim 28, further comprising:
a first mixer for frequency mixing the link signal with a first mixing signal having a first mixing frequency to form an intermediate frequency signal; and
a second mixer for frequency mixing the intermediate frequency signal with a second mixing signal having a second mixing frequency less than the coverage frequency if the first mixing signal is greater than the link frequency and greater than the coverage frequency if the second mixing frequency is less than the link frequency to form the coverage signal.

30. A link signal for conveying information corresponding to a wireless coverage signal exchanged with a mobile station in a cellular communication system, the link signal comprising:
a link signal upper-sideband corresponding to a coverage signal lower-sideband of the wireless coverage signal; and
a link signal lower-sideband corresponding to a coverage signal upper-sideband of the wireless coverage signal.

31. A link signal in accordance with claim 1, wherein the link signal comprises a frequency modulated carrier signal having a link frequency, the upper-sideband spectrally located above the link frequency and the lower-sideband spectrally located below the link frequency.
